(19) United States
(12) Patent Application Publication
(10) Pub. No.: US 2017/0374491 A1
(43) Pub. Date: Dec. 28, 2017

(54) METHOD FOR INSTRUCTING UPDATE OF SYSTEM INFORMATION, BASE STATION AND USER EQUIPMENT

(71) Applicants: Fangying XIAO, Shanghai (CN); Sharp Kabushiki Kaisha, Sakai City, Osaka (JP)

(72) Inventors: FANGYING XIAO, Shanghai (CN); RENMAO LIU, Shanghai (CN); NINGJUAN CHANG, Shanghai (CN)

(21) Appl. No.: 15/536,480

(22) PCT Filed: Dec. 16, 2015
(86) PCT No.: PCT/CN2015/097588

§ 371 Date: Jun. 15, 2017

(30) Foreign Application Priority Data
Dec. 16, 2014 (CN) 201410781617.1

(51) Int. Cl. H04W 4/00; H04W 88/02; H04W 68/02

(52) U.S. Cl. CPC H04W 4/005; H04W 68/02; H04W 88/02

(57) ABSTRACT

Provided are a method for instructing update of machine type communication (MTC) system information, a base station (BS) supporting MTC, and a user equipment (UE). The MTC system information comprises system information required by a first-type MTC UE and system information required by a second-type MTC UE. The method comprises: when system information required by a first-type MTC UE is updated and/or system information required by a second-type MTC UE is updated, generating an instruction message containing a related MTC system information update instruction identifier; and sending the generated instruction message. The embodiments of the present invention can reduce the number of times an MTC UE reads the system information, thereby saving on the energy consumption of the MTC UE.

### TECHNICAL FIELD

The present invention relates to the technical field of wireless communication, and more particularly relates to a method for machine type communication, a base station and a user equipment.

### BACKGROUND

With the rapid growth of mobile communication and the great progress of technologies, the world will become a fully interconnected network society where anyone or anything can get information and share data at any time and anywhere. It is estimated that by 2020, the number of interconnected devices will reach 50 billion, of which only about 10 billion may be mobile phones and tablet computers, and the others are machines communicating to each other rather than communicating to human beings. Therefore, how to design a system supporting a large number of machine communication devices is a subject to be further researched.

In the standard of a long term evolution (LTE) project of a third generation partnership project (3GPP), machine-to-machine communication is called machine type communication (MTC). MTC is a data communication service without human participation. The large-scale deployment of MTC user equipments can be applied to security, tracking, payment, measurement, consumer electronics and other fields, specifically involving in applications including video monitoring, supply chain tracking, intelligent meter reading, remote monitoring, and the like. The user equipment supporting the MTC (hereinafter referred to as MTC UE or MTC Users) typically requires low power consumption and supports low data transmission rate and low mobility. The existing LTE system is mainly used for human-to-human communication service. The key to achieving scale competitive advantages and application prospects of the MTC services is that the LTE network supports the low-cost MTC UE.

Furthermore, some MTC UEs need to be installed in basements of residential buildings or at positions protected by insulation foils, metal windows or thick walls of traditional buildings. Compared with conventional terminal devices (such as mobile phones, tablet computers, and the like) in the LTE network, air interfaces of these MTC UEs will suffer more severe penetration losses. It is decided in 3GPP to study the scheme design and performance evaluation of the MTC UE with additional coverage enhancement of 15 dB. Note that the MTC UE disposed in a poor network coverage area generally has the following characteristics: extremely low data transmission rate, unrestricted delay requirement and limited mobility. For the above characteristics of the MTC, the LTE network can further optimize some signaling and/or channels to better support the MTC services.

At the 64^{th} 3GPP RAN plenary session held in June 2014, a new work item on Rel-13-oriented even low-complexity and enhanced coverage for MTC was proposed (see NPL: RP-140990 New Work Item on Even Lower Complexity and Enhanced Coverage LTE UE for MTC, Ericsson, NSN). In the description of this working item, the LTE Rel-13 system requires an MTC UE (hereinafter referred to as a narrow-band MTC UE) that supports uplink and downlink radio frequency bandwidth of 1.4 MHz to operate at any system bandwidth (e.g., 1.4 MHz, 3 MHz, 5 MHz, 10 MHz, 15 MHz, 20 MHz, and the like) and provides a coverage enhancement function for such MTC UEs. In the system design, both the low-cost MTC UE and the enhanced coverage MTC UE shall adopt a uniform design scheme. One of main targets of this working item is to reduce the energy consumption of the MTC UE.

Taking into account the particularity of the MTC UE, it is agreed at the 79^{th} 3GPP TSG RAN1 meeting that new system information is defined for the MTC system, that is, the existing user equipment reads the existing system information, and the MTC UE reads the newly defined MTC system information. According to the fact that whether the MTC UE needs the coverage enhancement or not, the MTC UE can be classified into an MTC UE (called a CE UE) requiring the coverage enhancement, for example, some smart electric meters/smart water meters; and an MTC UE (called Normal UE, and also called conventional MTC UE) requiring no coverage enhancement, for example, a wearable device. The required system information of the two MTC UEs are different. If the CE UE and the Normal UE share all system information, the CE UE or the Normal UE may read some useless system information, resulting in extending time and increasing power consumption of the MTC UE for reading the system information. Also, the system information of the MTC UE needs to be transmitted according to a repetition grade required by the CE UE requiring the largest coverage enhancement, thus wasting the transmission resource. Furthermore, the larger the system information is, the more the required number of repetitions is. Therefore, the system information required by the CE UE is sent separately from the system information required by the Normal UE, and the system information which is not required by at least both of the CE UE and the Normal UE needs to be sent separately. That is, all (or part of) system information required by both the CE UE and the Normal UE is shared, and other system information is sent separately.

In the existing LTE system, a SystemInformationBlockType 1 message contains one information element (abbreviated as IE) systemInforValueTag for indicating whether the system information (except for MIB, SIB1, SIB10,SIB11, SIB12 and SIB14) has been updated. When the system information has been updated, a value of the systemInfoValueTag is modified (generally the value of systemInfoValueTag is added by one, a value range of the systemInfoValueTag is from 0 to 31, and when reaching the maximum value, the systemInfoValueTag is counted from 0). The UE can verify whether the pre-stored system information (same as above, except for the MIB, SIB1, SIB10, SIB11, SIB12 and SIB14) is still valid by determining whether the information element is modified. If this information element is modified, the UE considers that the stored system information is invalid and re-reads required system information; and otherwise, the UE considers that the stored system information is still valid. Furthermore, a cell can also use a paging message to inform the UE in an RRC_IDLE (radio resource control idle) state or an RRC_CONNECTED (radio resource control connected) state, of the modification of the system information. The paging message contains one information element systemInfoModification, if the paging message received by the UE contains said information element, it indicates that the system information (except for the SIB10, SIB11, SIB12 and SB14) will be modified at a next modification period.

Compared with the existing LTE system, in the LTE MTC system, as the system information required by the CE UE may be different from the system information required by the Normal UE, if only the information element SystemInfoValueTag in the SystemInformationBlockType1 message and/or the information element systemInfoModification in the paging message are used for indicating the update of the system information, the information element systemInfoValueTag in the SystemInformationBlockType 1 message and/or the information element systemInfoModification in the paging message will also be modified when the system information of the Normal UE has been updated and the system information of the CE UE is not updated. Accordingly, the CE UE reads the modification of the information element systemInfoValueTag in the SystemInformationBlockType 1 message and/or the information element systemInfoModification in the paging message, and therefore determines that the system information has been updated, and re-read the required system information, which increases the energy consumption of the CE UE and shortens the service life of a battery, or vice versa.

Therefore, a system information update indication mechanism capable of overcoming the above-mentioned problems and applicable to the LTE MTC system is required.

### SUMMARY

In order to achieve the above-mentioned objective, the present invention provides an update indication mechanism for MTC system information, which respectively indicates whether system information of a first type of MTC UE (such as CE UE) and system information of a second type of MTC UE (such as Normal UE) has been updated.

A method for sending an update indication of MTC system information is provided according to a first aspect of the present invention, where the MTC system information includes system information required by a first type of MTC UE and system information required by a second type of MTC UE. The method includes: generating an indication message containing an update indication identifier of the MTC system information when the system information required by the first type of MTC UE has been updated and/or the system information required by the second type of MTC UE has been updated; and sending the generated indication message.

In some embodiments of the present invention, the indication message is system information (SI-MTC) shared by the first type of MTC UE and the second type of MTC UE, and the update indication identifier of the MTC system information is a system information value identifier of the MTC UE.

In some embodiments of the present invention, the indication message is a paging message, and the update indication identifier of the MTC system information is a system information modification identifier of the MTC UE.

In some embodiments of the present invention, the update indication identifier of the MTC system information include at least one of: an update indication identifier of the system information required by the first type of MTC UE for indicating whether the system information required by the first type of MTC UE has been updated; an update indication identifier of the system information required by the second type of MTC UE for indicating whether the system information required by the second type of MTC UE has been updated; and an update indication identifier of the system information required by the MTC UE for indicating whether the system information shared by the first type of MTC UE and the second type of MTC UE has been updated.

In some embodiments of the present invention, the system information modification identifier of the MTC UE only includes a single identifier for indicating whether the system information required by the first type of MTC UE and the system information required by the second type of MTC UE has been updated through different values.

In some embodiments of the present invention, the sending the generated indication message may include sending the generated indication message to both the first type of MTC UE and the second type of MTC UE. As an alternative, the sending the generated indication message may include the sending the generated indication message only to a type of MTC UE (such as a CE UE or a Normal UE), with the system information required by which having been updated.

A method for receiving an update indication of MTC system information is provided according to a second aspect of the present invention, where the MTC system information includes system information required by a first type of user equipment UE and system information required by a second type of user equipment UE. The method includes: receiving an update indication message of the MTC system information from a base station; extracting an update indication identifier of the MTC system information from the update indication message of the MTC system information; and determining whether the system information required by the first type of MTC UE and/or the system information required by the second type of MTC UE has been updated according to the extracted update indication identifier of the MTC system information.

A method for updating MTC system information in an MTC UE is provided according to a third aspect of the present invention. The method includes: re-reading and storing required system information when re-establishing a radio resource control RRC connection or returning from an power-saving mode PSM to an RRC_IDLE state. The method may further include: periodically reading the required system information at a pre-defined system information update period or a system information update period configured by RRC signaling.

A base station supporting machine type communication (MTC) is provided according to a fourth aspect of the present invention, which includes: an MTC system information update indication generation module configured to generate an indication message containing an update indication identifier of MTC system information when system information required by a first type of user equipment UE has been updated and/or system information required by a second type of user equipment UE has been updated, where the MTC system information contains the system information required by the first type of MTC UE and the system information required by the second type of MTC UE; and a communication module configured to send the generated indication message.

A user equipment (MTC UE) supporting machine type communication is provided according to a fifth embodiment of the present invention, which includes: a communication module configured to receive an update indication message of MTC system information; an extraction module configured to extract an update indication identifier of the MTC system information from the update indication message of the MTC system information, where the MTC system information contains system information required by a first type of user equipment UE and system information required by a second type of user equipment UE; and an analysis module configured to determine whether the system information required by the first type of MTC UE and/or the system information required by the second type of MTC UE has been updated according to the extracted update indication identifier of the MTC system information.

A user equipment MTC UE supporting machine type communication is provided according to a sixth embodiment of the invention, which includes: a system information update module and a storage module. The system information update module is configured to re-read and store required system information when re-establishing a radio resource control RRC connection or returning from a power-saving mode PSM to an RRC_IDLE state; and periodically read the required system information at a pre-defined system information update period or a system information update period configured through RRC signaling. The storage module is configured to store the read system information.

In the embodiments of the present invention, whether the system information required by the first type of MTC UE (such as CE UE) and the system information required by the second type of MTC UE (such as Normal UE) have been updated are indicated separately, so that when the system information of the CE UE (or the Normal UE) has been updated, the Normal UE (or the CE UE) is not triggered to re-read the system information, thereby saving the energy consumption of the Normal UE (or the CE UE).

### BRIEF DESCRIPTION OF THE DRAWINGS

The above-mentioned and other features of the present invention will become more apparent through the following detail description in combination with the drawings. In the drawings:

FIG. 1 is a flow chart illustrating a method for indicating update of system information of an MTC system according to an embodiment of the present invention.

FIG. 2 is a schematic structural diagram illustrating an MTC system according to an embodiment of the present invention.

FIG. 3 is a flow chart illustrating a method for updating system information of an MTC UE according to another embodiment of the present invention.

In all drawings of the present invention, identical or similar elements are marked by same or similar reference numbers.

### DETAILED DESCRIPTION

The present invention is described in detail below in combination with the drawings and embodiments. Note that the present invention is not limited to the embodiments described below. Furthermore, for the sake of simplicity and convenience, the detail description of the known technology that is not directly related with the present invention is omitted, so as to prevent from misunderstanding the present invention.

The embodiments of the present invention are described in detail below by using an LTE mobile communication system and subsequent evolved versions thereof as an example of an application environment. However, the present invention is not limited to the following embodiments, but can be applied to more other wireless communication systems, for example, a future 5G cellular communication system. Unless otherwise stated expressly herein, both the mentioned base station (BS) and the mentioned user equipment (UE) refer to the base station and the user equipment supporting MTC.

To facilitate the description, the present invention is described below by respectively taking the CE UE and the Normal UE as examples of the first type of MTC UE and the second type of MTC UE. However, it should be appreciated that the principle of the present invention can be suitable for other types of MTC UE. The present invention is not limited in this aspect.

To facilitate the description, it is assumed that a part or all of system information shared by the CE UE and the Normal UE is denoted as SI_MTC, system information except the SI_MTC in system information required by the CE UE is denoted as SI_CE, and system information except the SI_MTC in system information required by the Normal UE is denoted as SI_Normal. In other words, if the SI_MTC includes all system information shared by the CE UE and the Normal UE, the SI_CE contains specific system information of the CE UE, while the SI_Normal contains specific system information of the Normal UE. If the SI_MTC only contains a part of the system information shared by the CE UE and the Normal UE, besides the specific system information of the CE UE, the SI_CE also contains other shared system information other than the SI_MTC, while the SI_Normal also includes other shared system information other than the SI_MTC besides the specific system information of the Normal UE. The SI_MTC may be one system information block (abbreviated as SIB), and may also be divided into multiple system information blocks. Similarly, the SI_CE and the SI_Normal may also be one or more system information blocks.

In the solution of the present invention, a specific update indication identifier of system information is carried in the SI_MTC or a paging message to indicate whether the SI_CE, the SI_Normal and the SI_MTC have been updated.

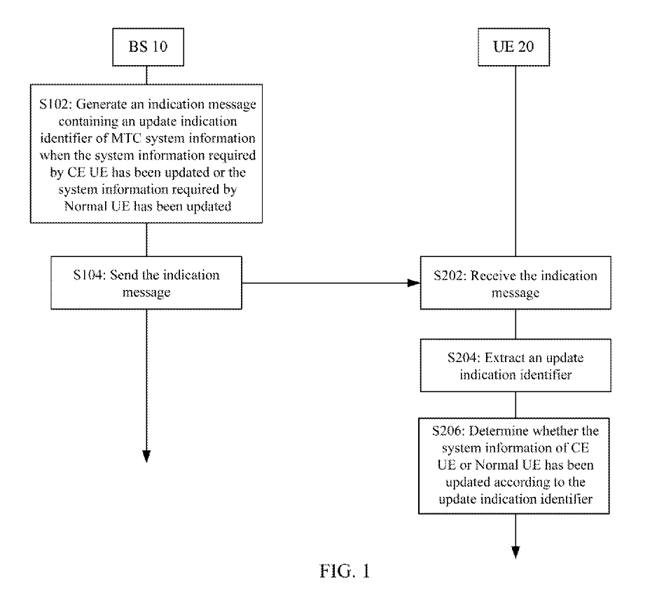

FIG. 1 is a flow chart illustrating a method for indicating update of system information of an MTC system according to an embodiment of the present invention. The MTC system includes one or more base stations BS 10 supporting MTC and one or more user equipments UE 20 supporting the MTC. In the system, one or more update indication identifiers of the MTC system information may be defined to indicate whether the SI_CE, the SI_Normal and the SI_MTC have been updated.

In step S102, the BS 10 generates an update indication message of the MTC system information containing an update indication identifier of the MTC system information when the system information required by the CE UE has been updated and/or the system information required by the Normal UE has been updated.

The update indication identifier of the MTC system information contained in the indication message may include at least one of: an update indication identifier of system information required by the CE UE for indicating whether the system information required by the CE UE has been updated; an update indication identifier of system information required by the Normal UE for indicating whether the system information required by the Normal UE has been updated; and an update indication identifier of the system information required by the MTC UE for indicating whether the system information shared by the CE UE and the Normal UE has been updated.

Then in step S104, the generated indication message is sent. The indication message may be sent in various ways. For example, the indication message may be sent to both the CE UE and the Normal UE. Alternatively, the indication message may be sent only to the CE UE or the Normal UE, with the system information required by which having been updated.

In step 202, the UE 20 receives the indication message sent by the base station.

In step 204, the UE 20 extracts the update indication identifier of the MTC system information from the received indication message.

Then, in step S206, the UE 20 determines whether the system information required by the CE UE and/or the system information required by the Normal UE has been updated according to the extracted update indication identifier of the MTC system information.

In some embodiments of the present invention, whether the system information required by the CE UE and the Normal UE has been updated is indicated by an MTC system information value identifier contained in the system information SI_MTC shared by the CE UE and the Normal UE. In these embodiments, the indication message may be the system information SI_MTC shared by the CE UE and the Normal UE or may be one of multiple information blocks formed by dividing the SI_MTC. The update indication identifier of the MTC system information may be a system information value identifier of the machine type communication user equipment MTC UE. Specifically, the system information value identifier of the MTC UE may include at least one of: a system information value identifier of the CE UE; a system information value identifier of the Normal UE; and a system information value identifier for indicating whether the system information shared by the CE UE and the Normal UE has been updated. These system information value identifiers may be an integer defined in a value range (for example, the value range is from 0 to 31) or other values for determining whether the system information is updated. The UE may determine whether system information has been updated by comparing whether the received system information value identifier with a system information value identifier stored locally. If the system information value identifier received by the UE is different from the system information value identifier stored locally, it indicates that the system information has been updated, and the UE re-reads required system information; or otherwise, the UE considers that the system information stored locally is still valid.

In some other embodiments of the present invention, whether the system information required by the CE UE and the Normal UE has been updated is indicated by a modification indication identifier of the MTC system information contained in the paging message. In these embodiments, the indication message may be the paging message. The update indication identifier of the MTC system information may be a system information modification identifier of the machine type communication user equipment MTC UE. Specifically, the system information modification identifier of the MTC UE may include at least one of: a system information modification identifier of the CE UE; a system information modification identifier of the Normal UE; and a system information modification identifier indicating whether the system information shared by the CE UE and the Normal UE has been updated. Particularly, the system information modification identifier of the MTC UE may also be a single identifier for indicating whether the system information required by the CE UE and the system information required by the Normal UE have been updated through different values. The UE may determine whether the system information has been updated by checking whether the received paging message contains the system information modification identifier of the MTC UE. If the paging message received by the UE contains system information modification identifier of the MTC UE, it indicates that the system information has been updated, and the UE re-reads required system information; or otherwise, the UE considers that the system information stored locally is still valid.

It shall be stated that similar to the existing LTE system, the updated system information indicated by the update indication identifier of the MTC system information may not contain some particular system information such as SIB10, SIB11, SIB12, and the like.

The above-mentioned two implementation ways are each described in detail below.

### A. System Information Contains a System Information Value Identifier

In one implementation way, two information elements systemInfoValueTag_CE (called a system information value identifier of the CE UE) and systemInfoValueTag_Normal (called a system information value identifier of the Normal UE) may be added into the SI_MTC. The information elements systemInfoValueTag_CE and systemInfoValueTag_Normal are respectively used to indicate whether the system information of the CE UE (for example, SI_MTC and SI_CE) and the system information of the Normal UE (for example, SI_MTC and SI_Normal) have been updated (except for the system information needing special update indication, for example, MIB). If the SI_MTC is divided into multiple system information blocks, the information element systemInfoValueTag_CE and the information element systemInfoValueTag_Normal may be contained in one of these system information blocks, for example, the information element systemInfoValueTag_CE and the information element systemInfoValueTag_Normal are contained in a first system information block shared by the CE UE and the Normal UE. The values of the information element systemInfoValueTag_CE and the information element systemInfoValueTag_Normal may be an integer defined in a value range (for example, the value range is from 0 to 31) or other values used to determine whether the system information has been updated. The CE UE (or the Normal UE) may determine whether the stored system information is valid by checking whether the systemInfoValueTag_CE (or systemInfoValueTag_Normal) in the SI_MTC is same with a value stored locally. If systemInfoValueTag_CE (or systemInfoValueTag_Normal) is different from the value stored locally, it indicates that the SI_CE (or SI_Normal) has been updated. The CE UE (or Normal UE) re-reads required system information. Otherwise, it indicates that the system information stored locally is still valid.

Optionally, in some circumstances, only one information element, for example, one of systemInfoValueTag_CE and systemInfoValueTag_Normal is added in the SI_MTC to indicate whether the system information of one of the CE UE and the Normal UE has already been updated (except for the system information requiring special update indication, such as MIB). A system information update period of the other one of the CE UE and the Normal UE may be determined according to a pre-defined way or through an RRC signaling configuration way. Therefore, the other one of the CE UE and the Normal UE may read the system information at the update period so as to acquire the updated system information. The update period may be determined according to a pre-defined way or through an RRC signaling configuration way.

For example, if the system information required by the CE UE is a subset of the shared system information SI_MTC, the SI_CE is empty. In that way, only the systemInfoValueTag_Normal may be defined in the SI_MTC to indicate whether the system information of the Normal UE has been updated. The CE UE does not read the information element systemInfoValueTag_Normal. The system information update period of the CE UE may be determined according to a pre-defined way or through an RRC signaling configuration way. Correspondingly, the CE UE may read the system information at the specific update period so as to acquire the updated system information.

For example, if the CE UE is in a non-RRC_IDLE state and non-RRC_CONNECTED state for a long time, for example, the CE UE is in an power-saving mode (PSM), when the CE UE is returned to the RRC_IDLE state or the RRC_CONNECTED state, the CE UE re-reads the required system information. In that way, only the systemInfoValueTag_Normal may be defined in SI_MTC to indicate whether the system information of the Normal UE has been updated. The CE UE does not read the information element systemInfoValueTag_Normal.

As another example, if the system information required by the Normal UE is a subset of the shared system information SI_MTC, the SI_normal is empty. In that way, only the information element systemInfoValueTag_CE may be defined in SI_MTC to indicate whether the system information of the CE UE has been updated. The Normal UE does not read the information element systemInfoValueTag_CE. The system information update period of the Normal UE is determined according to the pre-defined way or through the RRC signaling configuration way. The Normal UE may read the system information at the specific update period so as to acquire the updated system information.

For example, if the Normal UE is in a non-RRC_IDLE state and non-RRC_CONNECTED state for a long time, for example, the CE UE is in an power-saving mode (PSM), when the Normal UE is returned to the RRC_IDLE state or the RRC_CONNECTED state, the Normal UE re-reads the required system information. In that way, only the information element systemInfoValueTag_CE may be defined in the SI_MTC to indicate whether the system information of the CE UE has been updated or not. The Normal UE does not read the information element systemInfoValueTag_CE.

Optionally, besides the two information elements systemInfoValueTag_CE and systemInfoValueTag_Normal added in the SI_MTC, an information element systemInfoValueTag_MTC may also be added to indicate whether the system information SI_MTC shared by the CE UE and the Normal UE has been updated. In this circumstance, the meaning of the systemInfoValueTag_CE and the systemInfoValueTag_Normal may be as described above. Or preferably, the systemInfoValueTag_CE is only used to indicate whether the SI_CE has been updated, while the systemInfoValueTag_Normal is only used to indicate whether the SI_Normal has been updated. Therefore, in the preferable circumstance, when it is detected by the CE UE (or the Normal UE) that the systemInfoValueTag_MTU information element is changed but the systemInfoValueTag_CE (or systemInfoValueTag_Normal) is not changed, it can be determined accordingly that the SI_MTC has been updated and the SI_CE (or the SI_Normal) is not updated. In this case, the CE UE (or the Normal UE) only re-reads the SI_MTC, and considers that the stored SI_CE (or SI_Normal) is still valid.

Optionally, the SI_MTC may not contain the system information value identifier for indicating whether the system information of the CE UE and the Normal UE has been updated.

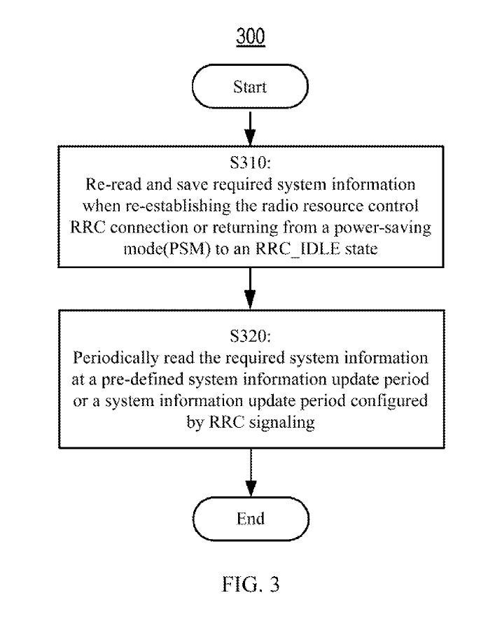

In this case, when the CE UE and the Normal UE reestablish a RRC connection or are returned from the PSM state to the RRC_IDLE state, the CE UE and the Normal UE re-read the required system information, which will be described below with reference to FIG. 3. When the CE UE and the Normal UE are in the RRC_IDLE state or the RRC_CONNECTED state, a system information update period of the system information is determined according to the pre-defined way or through the RRC signaling configuration way. The CE UE and the Normal UE read the system information at the update period so as to acquire the updated system information.

### B. The Paging Message Contains a System Information Modification Indication Identifier

### Solution 1:

The paging message may contain the information element systemInfoModification_Normal (called a system information modification identifier of the Normal UE) and the information element systemInfoModification_CE (called a system information modification identifier of the CE UE). The information element systemInfoModification_Normal is used to indicate that the system information required by the Normal UE has been updated. The information element systemInfoModification_CE is used to indicate that the system information required by the CE UE has been updated. When the system information required by the Normal UE has been updated, the paging message sent by the base station will contain the information element systemInfoModification_Normal. If the paging message received by the Normal UE contains the information element systemInfoModification_Normal, it indicates that the required system information will be modified in a next modification period. The Normal UE will re-read the required system information. When the system information of the CE UE has been updated, the paging message sent by the base station will contain the information element systemInfoModification_CE. If the paging message received by the CE UE contains the information element systemInfoModification_CE, it indicates that the required system information will be modified in a next modification period. The CE UE will re-read the required system information. Similar to the existing system LTE, the system information to be updated indicated by the information element systemInfoModification_Normal and the information element systemInfoModification_CE may not contain some system information requiring special update indication, such as SIB10, SIB11, SIB12, and the like.

Optionally, an information element systemInfoModification_MTC may also be defined in the paging message to indicate that the system information SI_MTC shared by the CE UE and the Normal UE has been updated. When the paging message received by the CE UE and the Normal UE contains the information element systemInfoModification_MTC (but does not contain the information element systemInfoModification_CE and the information element systemInfoModification_Normal), it indicates that the SI_MTC has been updated, but the SI_CE and the SI_Normal are not updated. In this case, the CE UE (or the Normal UE) only re-reads the SI_MTC, and considers that the stored SI_CE (or SI_Normal) is still valid. Optionally, when the paging message received by the CE UE and the Normal UE contains the information element systemInfoModification_MTC (but does not contain the information element systemInfoModification_CE and the information element systemInfoModification_Normal), the CE UE re-reads the SI_MTC and the SI_CE, and the Normal UE re-reads the Si_MTC and the SI_Normal. In this case, even the system information SI_CE of the CE UE or the system information SI_Normal of the Normal UE has been updated, the paging message may not contain the information element systemInfoModification_CE and the information element systemInfoModification_Normal.

Optionally, if the system information required by the CE UE is a subset of the shared system information SI_MTC, the SI_CE is empty. In this case, the paging message may contain the information element systemInfoModification_Normal (called a system information modification identifier of the Normal UE) and the information element systemInfoModification_MTC (called a system information modification identifier of the MTC UE). The information element systemInfoModification_MTC is used to indicate that the system information SI_MTC shared by the Normal UE and the CE UE has been updated. If the paging message received by the Normal UE contains the systemInfoModification_Normal, it indicates that the required system information will be modified in a next modification period. Then, the Normal UE re-reads the SI_MTC and SI_normal, or only reads the SI_normal (in a case that the stored SI_MTC is considered to be still valid). If the paging message received by the Normal UE and the CE UE contains the systemInfoModification_MTC, it indicates that the required system information will be modified in a next modification period. The CE UE re-reads the SI_MTC; the Normal UE re-reads the SI_MTC and the SI_normal, or only reads SI_MTC (in a case that the stored SI_Normal is considered to be still valid).

Optionally, if the system information required by the Normal UE is a subset of the shared system information SI_MTC, the SI_normal is empty. In this case, the information element systemInfoModification_MTC (called a system information modification identifier of the MTC UE) and the information element systemInfoModification_CE (called a system information modification identifier of the CE UE) may be defined in the paging message. If the paging message received by the CE UE contains the systemInfoModification_CE, it indicates that the required system information will be modified in a next modification period. Then, the CE UE re-reads the SI_MTC and the SI_CE, or only reads the SI_CE (in a case that the stored SI_MTC is then considered to be still valid). If the paging message received by the Normal UE and the CE UE contains the systemInfoModification_MTC, it indicates that the required system information will be modified in a next modification period. The Normal UE re-reads the SI_MTC; and the CE UE re-reads the SI_MTC and the SI_CE, or only reads the SI_MTC (in a case that the stored SI_CE is then considered to be still valid).

Optionally, if the CE UE is in a non-RRC_IDLE state and in a non-RRC_CONNECTED state for a long time, for example, the CE UE is in an power-saving mode (PSM), when the CE UE is returned to the RRC_IDLE state or the RRC_CONNECTED state, the CE UE re-reads the required system information. In this case, only the systemInfoModification_Normal may be defined in the paging message to indicate that the system information of the Normal UE has been updated. The CE UE does not read the information element systemInfoModification_Normal.

Optionally, if the Normal UE is in a non-RRC_IDLE state and in a non-RRC_CONNECTED state for a long time, for example, the CE UE is in an power-saving mode (PSM), when the Normal UE is returned to the RRC_IDLE state or the RRC_CONNECTED state, the Normal UE re-reads the required system information. In this case, only the systemInfoModification_CE may be defined in the paging message to indicate that the system information of the CE UE has been updated. The Normal UE does not read the information element systemInfoModification_CE.

Optionally, the paging message does not contain the system information modification indication identifier for indicating update of the system information of the CE UE and the Normal UE. In this case, when the CE UE and the Normal UE reestablish the RRC connection or are returned from the PSM state to the RRC_IDLE state, the CE UE and the Normal UE re-read the required system information. When the CE UE and the Normal UE are in the RRC_IDLE or the RRC_CONNECTED state, the system information update period of the system information is determined according to the pre-defined way or through the RRC signaling configuration way. The CE UE and the Normal UE read the system information at the specific update period so as to acquire the updated system information. which will be described below with reference to FIG. 3.

### Solution 2:

The paging message contains the information element systemInfoModification_MTC (called a modification identifier of the MTC system information). The information element systemInfoModification_MTC may has multiple values. For example, the information element systemInfoModification_MTC at least has three values, such as 1, 2 and 3. Different values of the information element systemInfoModification_MTC are each used to indicate whether the SI_MTC, the SI_Normal and the SI_CE have been updated. For example, the information element systemInfoModification_MTC with the value of 1 indicates that the system information of both the Normal UE and the CE UE has been updated; the information element systemInfoModification_MTC with the value of 2 indicates that the SI_Normal has been updated; and the information element systemInfoModification_MTC with the value of 3 indicates that the SI_CE has been updated. If the paging message received by the Normal UE contains the information element systemInfoModification_MTC with the value of 1 or 2, it indicates that the required system information will be modified in the next modification period. The Normal UE will re-read the required system information. If the paging message received by the CE UE contains the systemInfoModification_MTC information element with the value of 1 or 3, it indicates that the required system information will be modified in the next modification period. The CE UE will re-read the required system information. Similar to the existing LTE system, the system information to be updated indicated by the information element systemInfoModification_MTC may not contain some system information requiring special update indication, such as SIB10, SIB11, SIB12.

Optionally, if the system information required by the CE UE is a subset of the shared system information SI_MTC, the SI_CE is empty. Then the information element systemInfoModification_MTC contained in the paging message may have only two values, one of which is used to indicate whether the SI_MTC has been updated, and the other value is used to indicate whether SI_Normal has been updated. For example, the two values of the information element systemInfoModification_MTC are 1 and 2. If the value of the information element systemInfoModification_MTC is 1, it indicates that the system information SI_MTC shared by the Normal UE and the CE UE will be modified in the next modification period; and if the value of the information element systemInfoModification_MTC is 2, it indicates that the system information required by the Normal UE will be modified in the next modification period. If the paging message received by the Normal UE contains the information element systemInfoValueTag_MTC with the value of 2, it indicates that the required system information will be modified in a next modification period. The Normal UE will re-read the SI_MTC and SI_Normal, or only read the SI_normal (in a case that the stored SI_MTC is considered to be still valid). If the paging message received by the Normal UE contains the information element systemInfoValueTag_MTC with the value of 1, it indicates that the required system information will be modified in a next modification period. The Normal UE will re-read the SI_MTC and SI_Normal, or only read the SI_MTC (in a case that the stored SI_Normal is considered to be still valid). If the paging message received by the CE UE contains the information element systemInfoValueTag_MTC with the value of 1, it indicates that the required system information will be modified in the next modification period. The CE UE will re-read the SI_MTC.

Optionally, if the system information required by the Normal UE is a subset of the shared system information SI_MTC, the SI_normal is empty. Then the information element systemInfoModification_MTC contained in the paging message may have two values, one of which is used to indicate whether the SI_MTC has been updated, the other value is used to indicate whether SI_CE has been updated. For example: the two values of the information element systemInfoModification_MTC are 1 and 2. If the information element systemInfoModification_MTC has the value of 1, it indicates that the system information SI_MTC shared by the Normal UE and the CE UE will be modified in the next modification period; and if the information element systemInfoModification_MTC has the value of 2, it indicates that the system information required by the CE UE will be modified in the next modification period. If the paging message received by the CE UE contains the information element systemInfoValueTag_MTC with the value of 2, it indicates that the required system information will be modified in the next modification period. The CE UE re-reads the SI_MTC and the SI_CE, or only reads the SI_CE (in a case that the stored SI_MTC is then considered to be still valid). If the paging message received by the CE UE contains the information element systemInfoModification_MTC with the value of 1, it indicates that the required system information will be modified in the next modification period. The CE UE will re-read the SI_MTC and the SI_CE, or only read the SI_MTC (in a case that the stored SI_CE is considered to be still valid). If the paging message received by the Normal UE contains the information element systemInfoModification_MTC with the value of 1, it indicates that the required system information will be modified in the next modification period. The Normal UE will re-read the SI_MTC.

Optionally, the information element systemInfoModification_MTC contained in the paging message may have four values, such as 1, 2, 3 and 4. If the information element systemInfoModification_MTC has the value of 4, it indicates that the system information SI_MTC shared by the CE UE and the Normal UE has been updated, and the SI_CE and the SI_Normal remains unchanged. When detecting that the value of the information element systemInfoModification_MTC is 4, the CE UE and the Normal UE determine that the SI_MTC has been updated and the SI_CE and the SI_Normal are not updated. In this case, the CE UE and the Normal UE only re-read the SI_MTC, and consider that the stored SI_CE or SI_Normal is still valid.

Optionally, if the CE UE is in a non-RRC_IDLE state and in a non-RRC_CONNECTED state for a long time, for example, the CE UE is in a power-saving mode (PSM), when the CE UE is returned to the RRC_IDLE state or the RRC_CONNECTED state, the CE UE needs to re-read the required system information. In this case, only the systemInfoModification_Normal may be defined in the paging message to indicate that the system information of the Normal UE has been updated. The CE UE does not read the information element systemInfoModification_Normal. When the CE UE is in the RRC_IDLE state or the RRC_CONNECTED state, the system information update period of the CE UE system information is determined according to a pre-defined way or through an RRC signaling configuration way. The CE UE reads the system information at the update period so as to acquire the updated system information.

Optionally, if the Normal UE is in a non-RRC_IDLE state and in a non-RRC_CONNECTED state for a long time, for example, the CE UE is in an power-saving mode (PSM), when the Normal UE is returned to the RRC_IDLE state or the RRC_CONNECTED state, the Normal UE needs to re-read the required system information. In this case, only the systemInfoModification_CE may be defined in the paging message to indicate that the system information of the CE UE has been updated. The Normal UE does not read the information element systemInfoModification_CE. When the Normal UE is in the RRC_IDLE state or the RRC_CONNECTED state, the system information update period of the Normal UE system information is determined according to a pre-defined way or through an RRC signaling configuration way. The Normal UE reads the system information at the specific period so as to acquire the updated system information.

Note that, the value of the information element systemInfoModification_MTC in the present invention may be any distinguishable values.

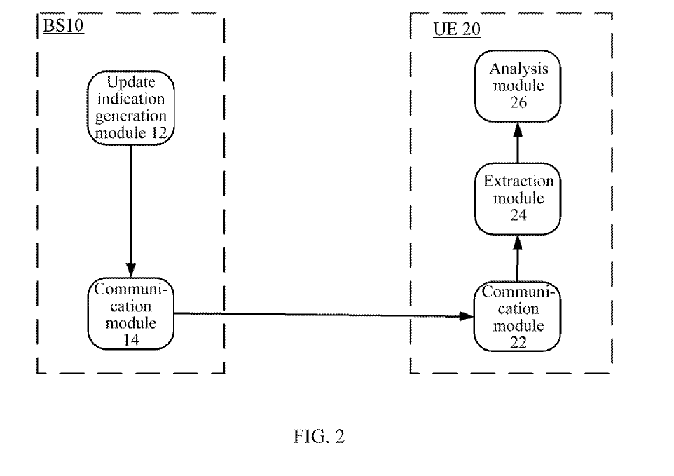

FIG. 2 is a schematic structural diagram illustrating an MTC system according to an embodiment of the present invention. The MTC system includes one or more base stations BS 10 supporting MTC and one or more user equipments UE 20 supporting the MTC, although one BS 10 and one UE 20 are illustrated in FIG. 2.

As illustrated in FIG. 2, the BS 10 may include an MTC system information update indication generation module 12 and a communication module 14. The MTC system information update indication generation module 12 is configured to generate an indication message containing an update indication identifier of MTC system information when system information required by the CE UE has been updated and/or system information required by the Normal UE has been updated, where the MTC system information contains the system information required by the CE UE and the system information required by the Normal UE. The communication module 14 is configured to send the generated indication message.

As illustrated in FIG. 2, the UE 20 may include a communication module 22, an extraction module 24 and an analysis module 26. The communication module 22 is configured to receive an update indication message of machine type communication MTC system information. The extraction module 24 is configured to extract an update indication identifier of the MTC system information from the update indication message of the MTC system information, where the MTC system information contains the system information required by the CE UE and the system information required by the Normal UE. The analysis module 26 is configured to determine whether the system information required by the CE UE and/or the system information required by the Normal UE has been updated according to the extracted update indication identifier of the MTC system information.

The BS 10 and the UE 20 can execute the method for indicating the update of the system information of the MTC system described above with reference to FIG. 1, which is not described repeatedly herein.

FIG. 3 is a flow chart illustrating a method 300 for updating system information of an MTC UE according to another embodiment of the present invention. The MTC UE may be the CE UE or may also be the Normal UE. The method 300 is applicable to the situation that the SI_MTC and the paging message do not contain the system information value identifier for indicating that the system information of the CE UE and the Normal UE has been updated.

As illustrated in FIG. 3, in step S310, the UE re-reads and stores required system information when re-establishing the radio resource control connection or returning from a power-saving mode (PSM) to an RRC_IDLE state.

In step S320, the UE periodically reads the required system information at a pre-defined system information update period or a system information update period configured by RRC signaling.

By using the method 300, although the SI_MTC and the paging message do not contain the system information value identifier for indicating the update of the system information of the CE UE and the Normal UE, the UE can still acquire the updated system information.

The method and related apparatuses of the present invention are described above in combination with preferred embodiments.

Those skilled in the art may understand that the method described above is only exemplary. The method of the present invention is not limited to the steps and sequences described above. The base station and the user equipment described above may include more modules, for example, may also include a storage unit, and the like. Various identifiers described above are only exemplary rather than for limitation, and the present invention is not limited to the information element as an example of these identifiers. Those skilled in the art can make various changes and modifications to the present invention according to the teaching of the described embodiments.

The present invention has the advantages that whether the system information required by the CE UE and the system information required by the Normal UE have been updated are indicated separately, so that when the system information of the CE UE (or the Normal UE) has been updated, the Normal UE (or the CE UE) is not triggered to re-read the system information, thereby saving the energy consumption of the Normal UE (or the CE UE).

It shall be appreciated that the above embodiments of the present invention can be implemented through software, hardware or a combination of the software and the hardware. For example, various components inside the base station and the user equipment in the above-mentioned embodiments can be implemented through various devices, and these devices include but are not limited to an analog circuit device, a digital circuit device, a digital signal processing (DSP) circuit, a programmable processor, an application-specific integrated circuit (ASIC), a field programmable gate array (FPGA), a complex programmable logic device (CPLD), and the like.

Furthermore, the embodiments of the present invention disclosed herein may also be implemented on a computer program product. More specifically, the computer program product is described as below. The product has a computer readable medium, on which computer program logic is encoded. The computer program logic provides relevant operations to implement the above-described technical solution of the present invention when the product is executed on a computing device. The computer program logic enables a processor to execute the operations (methods) described in the embodiments of the present invention when the product is executed on at least one processor of a computer system. Such an arrangement of the present invention is typically provided as software, a code, and/or other data structures that are configured or encoded on a computer-readable medium, such as an optical medium (for example CD-ROM), soft disk or hard disk, or for example, firmware or other media of microcodes on one or more ROM, RAM or PROM chips, or downloadable software images, shared databases and the like in one or more modules. The software, firmware or the such configuration can be installed on the computing device, so that one or more processors in the computing device execute the technical solution described in embodiments of the present invention.

Although the present invention has already been described in combination of preferred embodiments of the present invention, those skilled in the art shall appreciate that various modifications, substitutions and changes can be made to the present invention without departing from the spirit and scope of the present invention. Therefore, the present invention shall not be limited by the above-mentioned embodiments but shall be limited by the following claims and equivalences thereof.

1. A method for sending an update indication of machine type communication MTC system information, wherein the MTC system information comprises system information required by a first type of machine type communication user equipment MTC UE and system information required by a second type of machine type communication user equipment MTC UE, the method comprises:
generating an indication message containing an update indication identifier of the MTC system information when the system information required by the first type of MTC UE has been updated and/or the system information required by the second type of MTC UE has been updated; and
sending the generated indication message.

2. The method according to claim 1, wherein the indication message is system information SI_MTC shared by the first type of MTC UE and the second type of MTC UE, and the update indication identifier of the MTC system information is a system information value identifier of the machine type communication user equipment MTC UE.

3. The method according to claim 1, wherein the indication message is a paging message, and the update indication identifier of the MTC system information is a system information modification identifier of the machine type communication user equipment MTC UE.

4. The method according to claim 1, wherein the update indication identifier of the MTC system information comprises at least one of:
an update indication identifier of the system information required by the first type of MTC UE for indicating whether the system information required by the first type of MTC UE has been updated;
an update indication identifier of the system information required by the second type of MTC UE for indicating whether the system information required by the second type of MTC UE has been updated; and
an update indication identifier of the system information required by the MTC UE for indicating whether the system information shared by the first type of MTC UE and the second type of MTC UE has been updated.

5-6. (canceled)

7. A method for receiving an update indication of machine type communication MTC system information, wherein the MTC system information comprises system information required by a first type of user equipment UE and system information required by a second type of user equipment UE, and the method comprises:
receiving an update indication message of the MTC system information from a base station:
extracting an update indication identifier of the MTC system information from the update indication message of the MTC system information; and
determining whether the system information required by the first type of MTC UE and/or the system information required by the second type of MTC UE has been updated according to the extracted update indication identifier of the MTC system information.

8. The method according to claim 7, wherein the indication message is system information shared by the first type of MTC UE and the second type of MTC UE, and the update indication identifier of the MTC system information is a system information value identifier of the machine type communication user equipment MTC UE.

9. The method according to claim 7, wherein the indication message is a paging message, and the update indication identifier of the MTC system information is a system information modification identifier of the machine type communication user equipment MTC UE.

10. The method according to claim 7, wherein the update indication identifier of the MTC system information comprise at least one of:
an update indication identifier of the system information required by the first type of MTC UE for indicating whether the system information required by the first type of MTC UE has been updated;
an update indication identifier of the system information required by the second type of MTC UE for indicating whether the system information required by the second type of MTC UE has been updated; and
an update indication identifier of the system information required by the MTC UE for indicating whether the system information shared by the first type of MTC UE and the second type of MTC UE has been updated.

11-13. (canceled)

14. A base station supporting machine type communication, comprising:
an MTC system information update indication generation module configured to generate an indication message containing an update indication identifier of MTC system information when system information required by a first type of machine type communication user equipment MTC UE has been updated and/or system information required by a second type of machine type communication user equipment MTC UE has been updated,
wherein the MTC system information contains the system information required by the first type of MTC UE and the system information required by the second type of MTC UE, and
a communication module configured to send the generated indication message.

15. The base station according to claim 14, wherein the indication message is system information shared by the first type of MTC UE and the second type of MTC UE, and the update indication identifier of the MTC system information is a system information value identifier of the machine type communication user equipment MTC UE.

16. The base station according to claim 14, wherein the indication message is a paging message, and the update indication identifier of the MTC system information is a system information modification identifier of the machine type communication user equipment MTC UE.

17. The base station according to claim 14, wherein the update indication identifier of the MTC system information comprise at least one of:
an update indication identifier of the system information required by the first type of MTC UE for indicating whether the system information required by the first type of MTC UE has been updated;
an update indication identifier of the system information required by the second type of MTC UE for indicating whether the system information required by the second type of MTC UE has been updated; and
an update indication identifier of the system information required by the MTC UE for indicating whether the system information shared by the first type of MTC UE and the second type of MTC UE has been updated.

18-19. (canceled)

20. A user equipment supporting machine type communication MTC UE, comprising:
a communication module configured to receive an update indication message of machine type communication MTC system information;
an extraction module configured to extract an update indication identifier of the MTC system information from the update indication message of the MTC system information, wherein the MTC system information contains system information required by a first type of machine type communication user equipment MTC UE and system information required by a second type of machine type communication user equipment MTC UE; and
an analysis module configured to determine whether the system information required by the first type of MTC UE and/or the system information required by the second type of MTC UE has been updated according to the extracted update indication identifier of the MTC system information.

21. The MTC UE according to claim 20, wherein the indication message is system information shared by the first type of MTC UE and the second type of MTC UE, and the update indication identifier of the MTC system information is a system information value identifier of the machine type communication user equipment MTC UE.

22-26. (canceled)
